(19) United States
(12) Patent Application Publication
(10) Pub. No.: US 2026/0021750 A1
(43) Pub. Date: Jan. 22, 2026

(54) LONG SLIDE RAIL SYSTEM FOR VEHICLE SEAT

(71) Applicant: HYUNDAI TRANSYS INC., Seosan-si (KR)

(72) Inventors: Cheon KIM, Hwaseong-si (KR); Seong Jun HWANG, Hwaseong-si (KR); Heoung Su LIM, Hwaseong-si (KR); Kyeong Ho SEO, Suwon-si (KR); Jung Hyun HAN, Hwaseong-si (KR)

(21) Appl. No.: 19/268,183

(22) Filed: Jul. 14, 2025

(30) Foreign Application Priority Data
Jul. 17, 2024 (KR) 10-2024-0094247

(51) Int. Cl. B60N 2/08; B60N 2/07

(52) U.S. Cl. CPC B60N 2/0806; B60N 2/0715

(57) ABSTRACT

A long slide rail system for a vehicle seat, includes a lower rail extending lengthwise along a vehicle floor panel, the lower rail being fixedly installed on the floor panel, an upper rail coupled to the lower rail and configured for a seat cushion to be slidably moved along the lower rail, a locking module mounted on the upper rail, wherein the upper rail is slidably moved based on the locking module being unlocked from a locking hole formed in the lower rail, a fixing guide coupled to the upper rail and spaced apart from the locking module in a forward-and-rearward direction, and a moving guide selectively moved and connected to the fixing guide based on the locking module being locked in the locking hole. The moving guide is configured to control, inside the lower rail, horizontal and vertical clearances with respect to the upper rail.

### CROSS-REFERENCE TO RELATED APPLICATION

This application claims priority, under 35 U.S.C. § 119(a), to Korean Patent Application No. 10-2024-0094247, filed on Jul. 17, 2024, the entire contents of which are incorporated herein by reference.

### BACKGROUND

### (a) Technical Field

The present disclosure relates to a long slide rail system for a vehicle seat, and more particularly, to a long slide rail system for a vehicle seat, configured to prevent movement of the vehicle seat by restricting a vertical clearance and a horizontal clearance between a lower rail and an upper rail.

### (b) Background Art

In general, a vehicle seat includes a seatback and a seat cushion and is mounted on a seat sliding device configured to allow the seat cushion to be slidably moved in the forward-and-rearward direction of a vehicle body.

Normally, a front seat is mounted on a sliding device formed to have a short longitudinal length and configured to provide a short forward-and-rearward movement distance. Conversely, in the case of recreational vehicles (RVs) and vans having a larger vehicle body and a larger floor panel than those of passenger cars, a sliding device formed to have a long longitudinal length is installed therein to increase a degree of adjustment for a forward-and-rearward movement distance of a vehicle seat. Accordingly, sufficient leg room for a passenger may be secured, and a comfortable interior living space may be provided.

Typically, a long slide rail system is configured to provide a longer forward-and-rearward movement distance (approximately 400 to 1,000 mm) than a forward-and-rearward movement distance (approximately 200 to 300 mm) of a short slide rail system. Further, the long slide rail system is configured to include a lower rail embedded and mounted in a floor panel of a vehicle, and an upper rail connected to the lower rail so as to be movable along the lower rail in the forward-and-rearward direction and configured to be assembled with a vehicle seat.

In the long slide rail system, as the length of the lower rail increases, the dimensions of each section of the long slide rail system may not be constant. Accordingly, the following problems may occur due to a dimensional distribution.

First, since the upper rail is assembled with the lower rail where a dimensional distribution for each section is present, clearances present in some sections may be secured, but clearances present in other sections may not be reliably secured due to a dimensional distribution. In this case, vibration and shaking of the upper rail may occur when the upper rail slidably moves along the lower rail.

Second, since the dimensions of each section of the lower rail are not constant, a degree of coupling between the lower rail and a clearance-controlling member such as a roller or an injection-molded product may vary in each section, leading to a difference in operating force when the upper rail slidably moves along the lower rail. Accordingly, customers may have an unsatisfactory operational feeling when operating a seat, and thus marketability of the seat may deteriorate. As a result, it is difficult to improve marketability and quality of the seat due to the above-described problems.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an aspect of the present disclosure to provide a long slide rail system for a vehicle seat, configured to prevent vertical movement and horizontal movement of the vehicle seat in a fixed state in such a manner that a rotation bracket is rotated by elastic force when a locking module is located to be caught by a lower rail, a moving guide connected to the rotation bracket is slidably moved toward a fixing guide so as to be mounted on the fixing guide, and a vertical clearance and a horizontal clearance of the lower rail are controlled by the inclined shape of the fixing guide.

In one aspect, the present disclosure provides a long slide rail system for a vehicle seat, the long slide rail system including a lower rail configured to extend lengthwise along a floor panel of a vehicle, the lower rail configured to be fixedly installed on a floor panel, an upper rail coupled to the lower rail, the upper rail being configured for a seat cushion to be slidably moved along the lower rail, a locking module mounted on the upper rail, wherein the upper rail is configured to be slidably moved upon the locking module being unlocked from a locking hole formed in the lower rail, a fixing guide coupled to the upper rail, the fixing guide being spaced apart from the locking module in forward-and-rearward directions, and a moving guide configured to be selectively moved and connected to the fixing guide based on the locking module being locked in the locking hole, the moving guide configured to control, inside the lower rail, a horizontal clearance and a vertical clearance with respect to the upper rail.

In a preferred embodiment, the fixing guide may include a main body fixedly coupled to the upper rail, a pair of first support members positioned to face each other, the first support members formed to stand upright relative to the main body, and a pair of second support members extending respectively from the first support members, wherein a step is formed between each of the first support members and each of the second support members.

In another preferred embodiment, the first support members may be disposed such that a gap formed between the first support members is gradually increased in a forward movement direction of the moving guide.

In still another preferred embodiment, the second support members may be formed to be integrated with the first support members, may extend from the respective first support members in a state of being disposed parallel to each other, and may include upper surfaces formed to be inclined upwards in a forward direction in which the moving guide is moved.

In yet another preferred embodiment, the moving guide may include a pair of rotation brackets rotatably coupled to the locking module in a direction facing the fixing guide, and guide brackets rotatably coupled to the respective rotation brackets, wherein the guide brackets are formed to be selectively moved in conjunction with rotation of the respective rotation brackets so as to be connected to the first support members and the second support members.

In still yet another preferred embodiment, the rotation brackets may be connected to each other by an elastic member, and the rotation brackets may be configured to, based on the locking module being rotated to be unlocked from the locking hole, rotate in conjunction with rotation of the locking module so as to temporarily and elastically move the respective guide brackets in a direction allowing the guide brackets to be disconnected from the first support members and the second support members.

In a further preferred embodiment, each of the rotation brackets may include a protruding member formed to protrude toward the locking module.

In another further preferred embodiment, the guide bracket may include a body portion connected to the main body of the fixing guide, the body portion being configured to be movable in the forward-and-rearward direction, first mounting portions formed to extend in leftward-and-rightward directions relative to the body portion, the first mounting portions configured to be selectively connected to the respective first support members, and second mounting portions formed to extend upwards from the respective first mounting portions, the second mounting portions configured to be selectively connected to the respective second support members.

In still another further preferred embodiment, each of the first mounting portions may include a rubber member coupled to an outer surface of each of the first mounting portion so as to contact a side surface of the lower rail.

In yet another further preferred embodiment, each of the second mounting portions may include a connecting member formed to have a C-shaped cross-section so as to accommodate a corresponding one of the second support members inside the connecting member, and a roller member coupled to an outer surface of the connecting member so as to contact an upper surface of the lower rail.

In still yet another further preferred embodiment, the body portion may include an elastic member connected to the main body of the fixing guide and disposed on a front side of the body portion, the elastic member being configured to selectively provide, to the body portion, an elastic restoring force in a compressed state when the body portion is moved toward the fixing guide.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1 and 2 are views each showing a long slide rail system for a vehicle seat according to an embodiment of present closure;

FIG. 3 is a view showing a state in which a horizontal clearance and a vertical clearance of a moving guide are controlled in the long slide rail system for a vehicle seat according to the embodiment of the present disclosure;

FIG. 4 is a view showing a state in which the moving guide is separated from the long slide rail system for a vehicle seat according to the embodiment of the present disclosure;

FIG. 5 is a view showing a state in which the moving guide and a fixing guide are coupled to each other in the long slide rail system for a vehicle seat according to the embodiment of the present disclosure;

FIGS. 6 and 7 are views each showing an operating state of a rotation bracket in the long slide rail system for a vehicle seat according to the embodiment of the present disclosure;

FIGS. 8A and 8B are views each showing a first support member and a second support member in the long slide rail system for a vehicle seat according to the embodiment of the present disclosure; and

FIGS. 9 to 12 are views each showing an operating state of the moving guide in the long slide rail system for a vehicle seat according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, a preferred embodiment according to the present disclosure will be described in detail with reference to the accompanying drawings.

Advantages and features of the present disclosure and methods of achieving the same will become more apparent with reference to the embodiments described below in detail and the accompanying drawings.

However, the present disclosure is not limited by the embodiments disclosed below, and may be implemented in various forms. The embodiments are provided to make the present disclosure complete, and to fully inform those skilled in the art to which the present disclosure pertains of the scope of the disclosure, and the present disclosure is only defined by the scope of the claims.

In describing the embodiments disclosed herein, when it is determined that a detailed description of publicly known techniques to which the disclosure pertains may obscure the gist of the present disclosure, detailed description thereof will be omitted.

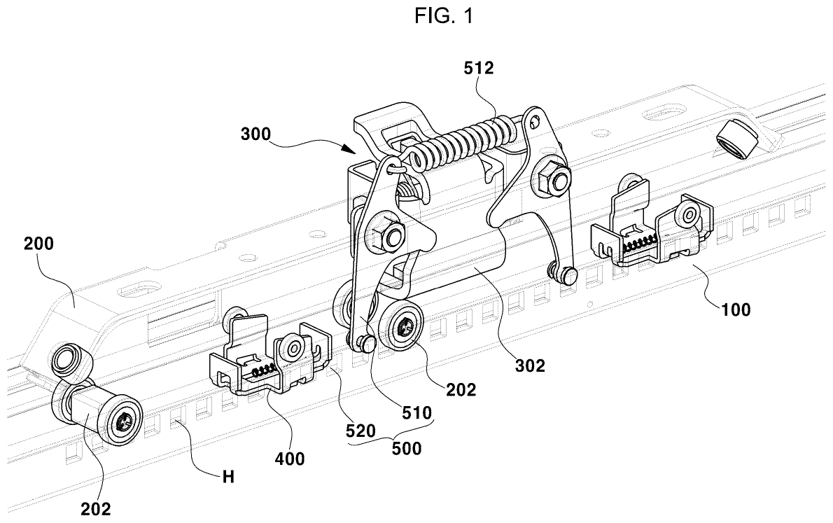

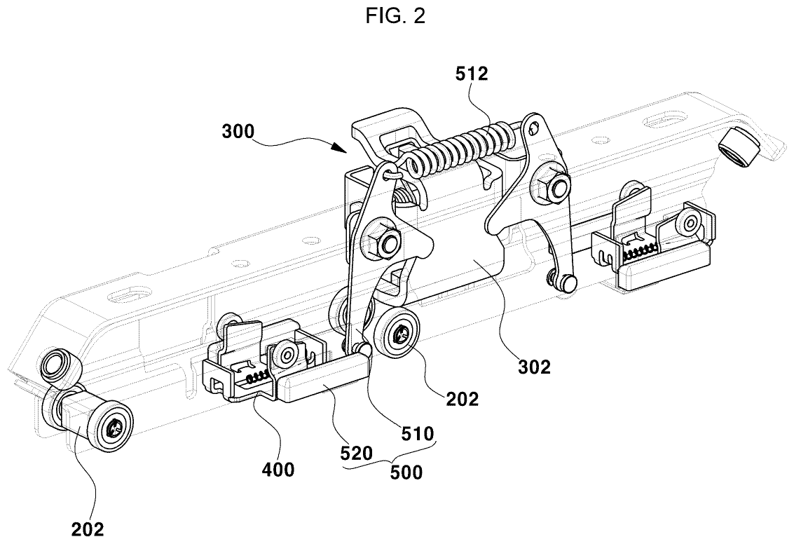

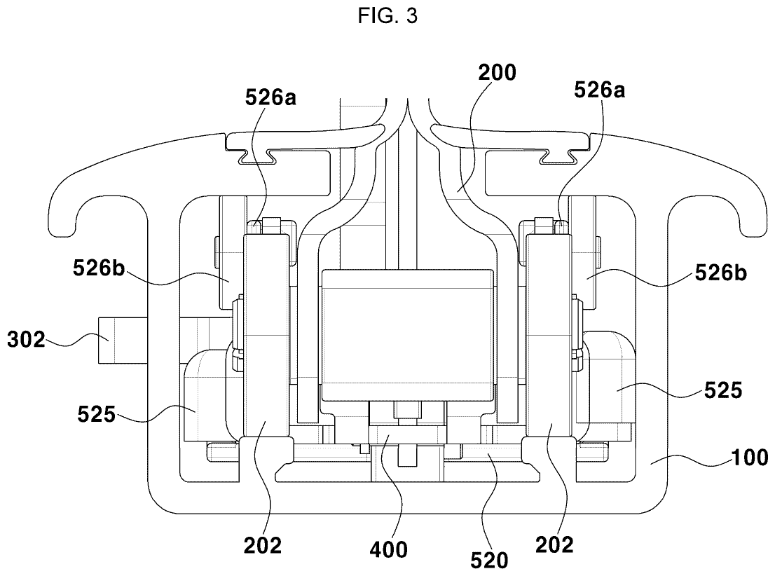

FIGS. 1 and 2 are views each showing a long slide rail system for a vehicle seat according to an embodiment of present closure, and FIG. 3 is a view showing a state in which a horizontal clearance and a vertical clearance of a moving guide are controlled in the long slide rail system for a vehicle seat according to the embodiment of the present disclosure.

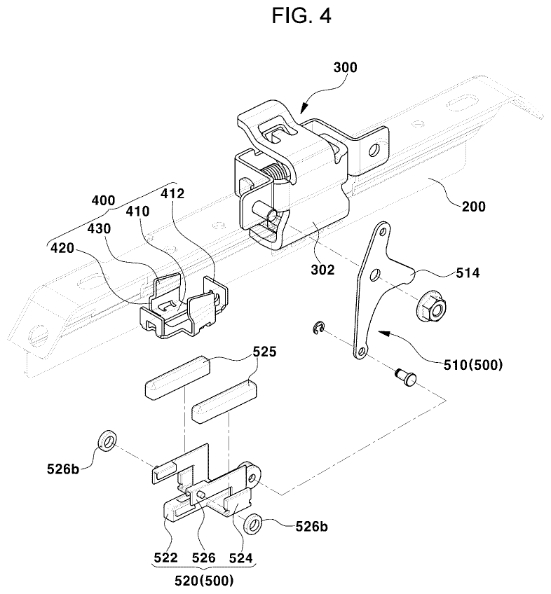

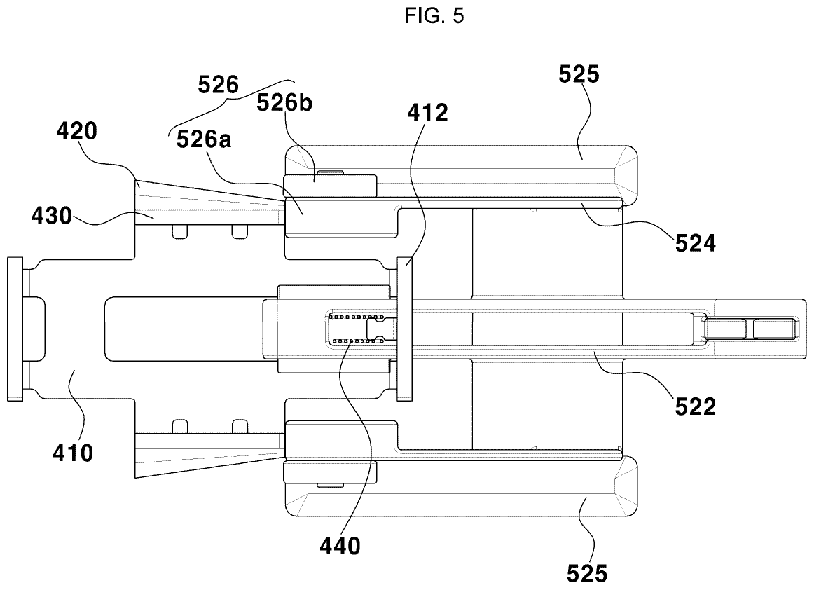

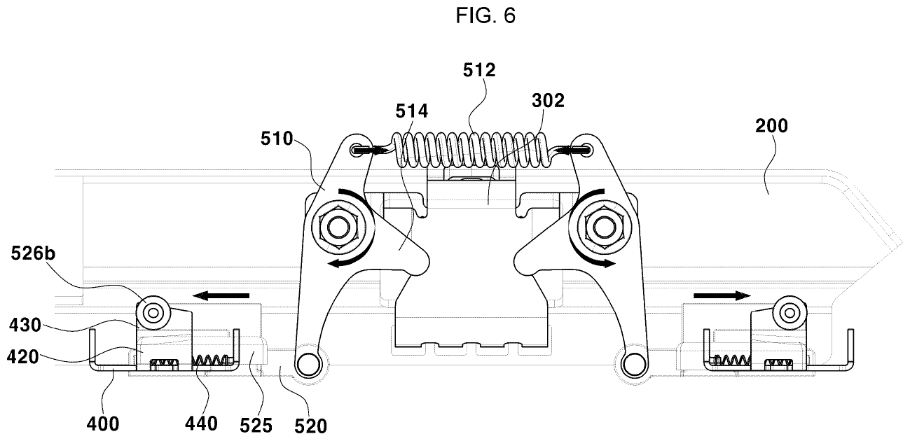

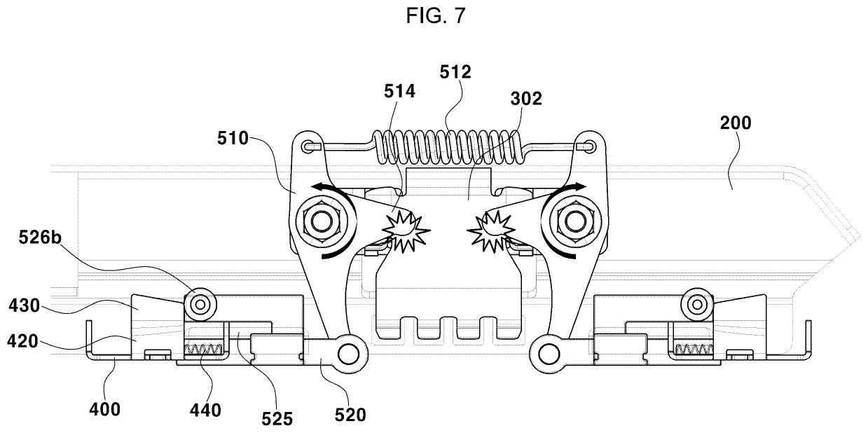

Additionally, FIG. 4 is a view showing a state in which the moving guide is separated from the long slide rail system for a vehicle seat according to the embodiment of the present disclosure, FIG. 5 is a view showing a state in which the moving guide and a fixing guide are coupled to each other in the long slide rail system for a vehicle seat according to the embodiment of the present disclosure, and FIGS. 6 and 7 are views each showing an operating state of a rotation bracket in the long slide rail system for a vehicle seat according to the embodiment of the present disclosure.

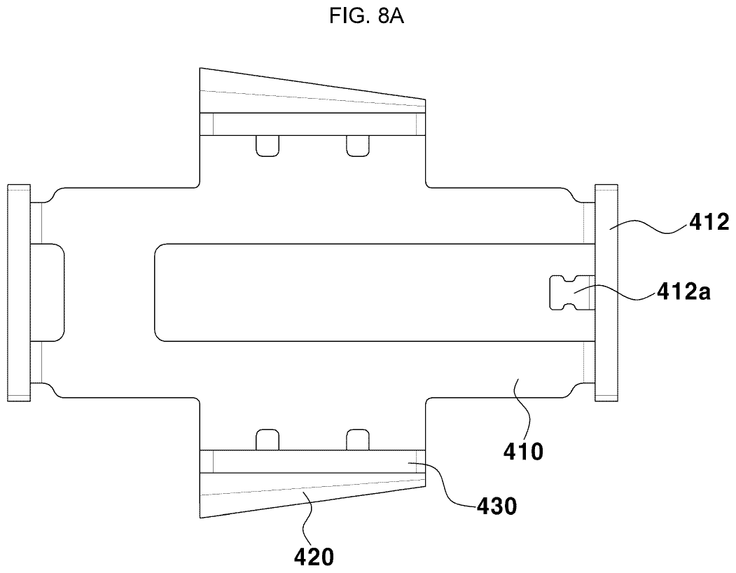

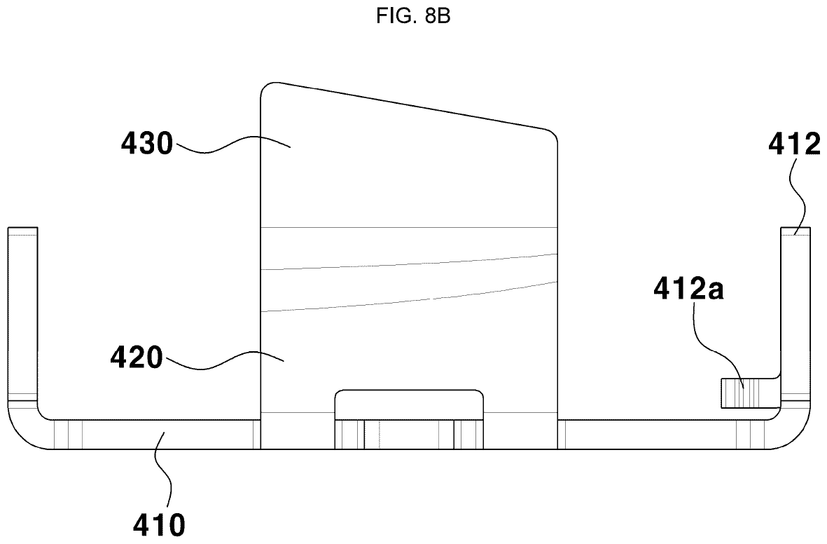

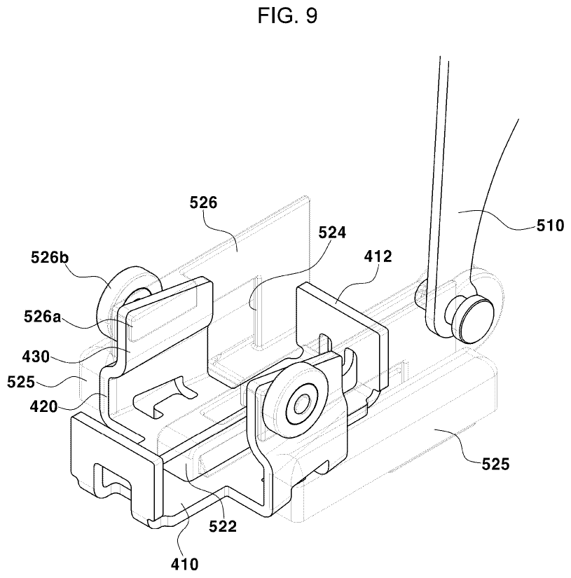

Furthermore, FIGS. 8A and 8B are views each showing a first support member and a second support member in the long slide rail system for a vehicle seat according to the embodiment of the present disclosure, and FIGS. 9 to 12 are views each showing an operating state of the moving guide in the long slide rail system for a vehicle seat according to the embodiment of the present disclosure.

As shown in FIGS. 1 and 2, the long slide rail system for a vehicle seat according to the present embodiment includes a lower rail 100, an upper rail 200, a locking module 300, a fixing guide 400, and a moving guide 500.

The lower rail 100 extends lengthwise along a floor panel of a vehicle and is fixedly installed on the floor panel.

The upper rail 200 is coupled to the lower rail 100, and a seat cushion constituting a vehicle seat is coupled to the upper rail 200 so as to be slidably moved along the lower rail 100.

To this end, the upper rail 200 may include a plurality of rollers 202, and the upper rail 200 may be slidably moved in the forward-and-rearward direction of the lower rail 100 via the rollers 202.

Further, the locking module 300 includes a lock fork 302. The lock fork 302 is vertically rotatably mounted on the upper rail 200. When the lock fork 302 is rotated to be unlocked from a locking hole H formed in the lower rail 100, the upper rail 200 may be slidably moved.

More specifically, in a locking mode of the vehicle seat, the lock fork 302 is located to be locked in the locking hole H so as to restrict sliding movement of the upper rail 200, and in a moving mode, the lock fork 302 is unlocked from the locking hole H through axial rotation thereof on the upper rail 200 so as to enable sliding movement of the upper rail 200.

A pair of fixing guides 400 is provided, and the fixing guides 400 are spaced apart from each other in the forward-and-rearward direction of the locking module 300 on the upper rail 200. Further, each of the fixing guides 400 accommodates a lower portion of the upper rail 200 therein and is fixedly coupled thereto by welding or the like.

As shown in FIGS. 8A and 8B, the fixing guide 400 includes a main body 410, a first support member 420, and a second support member 430.

The main body 410 has a connecting member 412 configured for the moving guide 500 to be connected thereto and formed to stand upright therefrom, and is fixedly connected to the upper rail 200.

Here, as shown in FIG. 5, a fixing member 412a is formed to protrude from the connecting member 412 and is configured to fix an elastic member 440. Since the fixing member 412a may fix the position of the elastic member 440 accommodated in a body portion 522 of the moving guide 500, elasticity may be selectively provided to the moving guide 500, the movement of which is determined by the moving mode or the locking mode.

A pair of first support members 420 is provided. Here, the first support members 420 are formed to stand upright and are located to face each other on both side surfaces of the main body 410.

Preferably, the first support members 420 may be disposed to be inclined in a direction in which the first support members 420 are separated from each other on the side surfaces of the main body 410. More preferably, a gap formed between the first support members 420 may be gradually increased in a direction in which the moving guide 500 is moved (refer to FIG. 8A).

Additionally, a step is formed between each of the second support members 430 and each of the first support members 420. The second support members 430 are formed to stand upright in a state of being disposed parallel to each other.

In addition, the second support members 430 may be formed to be integrated with the first support members 420 and may extend upwards from the first support members 420. Preferably, the upper surface of each of the second support members 430 may be formed to be gradually inclined upwards in a direction in which the moving guide 500 is moved (refer to FIG. 8B).

Meanwhile, the moving guide 500 is selectively moved when the lock fork 302 is located to be locked in the locking hole H and then is connected to the first support member 420 and the second support member 430. Thereafter, as shown in FIG. 3, the moving guide 500 is formed to control, inside the lower rail 100, a horizontal clearance and a vertical clearance with respect to the upper rail 200.

To this end, the moving guide 500 may include a rotation bracket 510 and a guide bracket 520, as shown in FIG. 4.

A pair of rotation brackets 510 is rotatably axially coupled to the locking module 300. Here, the rotation brackets 510 are disposed in a direction facing the respective fixing guides 400.

The upper portions of the rotation brackets 510 may be connected to each other by an elastic member 512 (refer to FIGS. 1 and 2). Through such a structural configuration, when the lock fork 302 is rotated to be unlocked from the locking hole H in the moving mode, the rotation brackets 510 may temporarily elastically move the respective guide brackets 520 in a direction in which the guide brackets 520 are disconnected from the first support members 420 and the second support members 430.

In other words, as shown in FIG. 6, when elastic restoring force of the elastic member 512 is applied to the rotation brackets 510, in the locking mode, the rotation brackets 510 are rotated to cause the upper portions thereof to face each other, and the guide brackets 520 are connected to the respective fixing guides 400. Meanwhile, as shown in FIG. 7, in the moving mode, the rotation brackets 510 are rotated to cause the upper portions thereof to be spaced apart from each other by the locking module 300, and the guide brackets 520 are disconnected from the respective fixing guides 400.

Here, each of the rotation brackets 510 is provided with a protruding member 514 formed to protrude toward the locking module 300. When the lock fork 302 is rotated to switch from the locking mode to the moving mode, the protruding member 514 is pressed by the rotating lock fork 302 to enable rotational movement of the rotation bracket 510 for movement of the guide bracket 520.

In addition, as shown in FIGS. 4 and 5, one side of the guide bracket 520 is rotatably coupled to the rotation bracket 510, the other side thereof is coupled to the connecting member 412. Here, when the rotation bracket 510 is rotated with respect to the locking module 300 to enter the locking mode, the guide bracket 520 is formed to be selectively moved so as to be connected to the first support member 420 and the second support member 430.

This guide bracket 520 includes a body portion 522, a first mounting portion 524, and a second mounting portion 526.

The body portion 522 is connected to the connecting member 412 of the main body 410 and is formed to be movable in the forward-and-rearward direction.

The elastic member 440 mounted on the fixing member 412a may be accommodated in the front side of the body portion 522 such that the body portion 522 is connected to the connecting member 412 (refer to FIG. 5).

The first mounting portion 524 extends in the leftward-and-rightward direction of the body portion 522 and is formed to be selectively connected to the first support member 420.

Preferably, the first mounting portion 524 may be made of an elastic material such that, when the first mounting portion 524 is connected to the first support member 420, the first mounting portion 524 is bent by a predetermined range corresponding to the shape of the second support member 420 (refer to FIG. 8A).

The first mounting portion 524 may have a rubber member 525 mounted thereon, and the rubber member 525 is coupled to the outer surface of the first mounting portion 524 so as to be in contact with the side surface of the lower rail 100 (refer to FIG. 3). Here, in the locking mode, when the first mounting portion 524 is connected to the first support member 420, it is possible to control a horizontal clearance of the moving guide 500 with respect to the fixing guide 400. As a result, it is possible to control a horizontal clearance with respect to the upper rail 100.

The second mounting portion 526 extends toward the upper side of the first mounting portion 524 and is formed to be selectively connected to the second support member 430.

The second mounting portion 526 has a connecting member 526a and a roller member 526b.

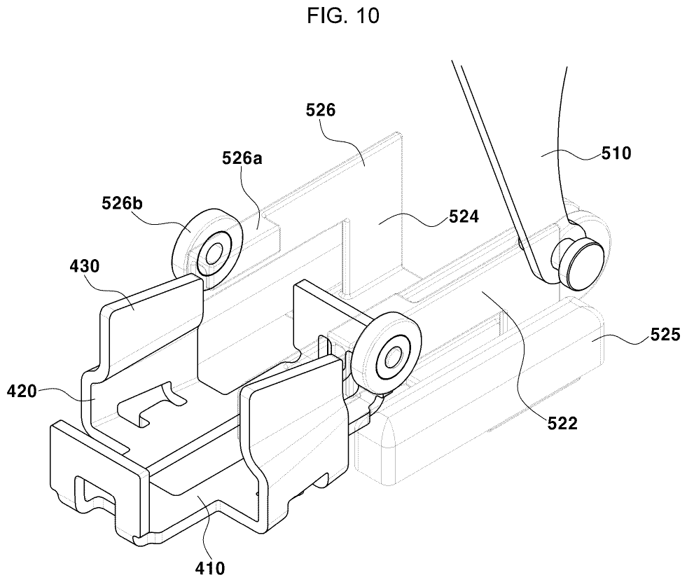

The connecting member 526a is formed to have a “C” shape to accommodate the second support member 430 therein, as shown in FIGS. 9 and 10.

As described above, the upper surface of the second support member 430 is formed to be gradually inclined upwards (refer to FIG. 8B). Accordingly, when the body portion 522 is moved due to switching to the locking mode, the connecting member 526a is moved along the inclined upper surface of the second support member 430 in a state of accommodating therein the upper surface of the second support member 430. Then, the roller member 526b may come into contact with the upper surface of the lower rail 100.

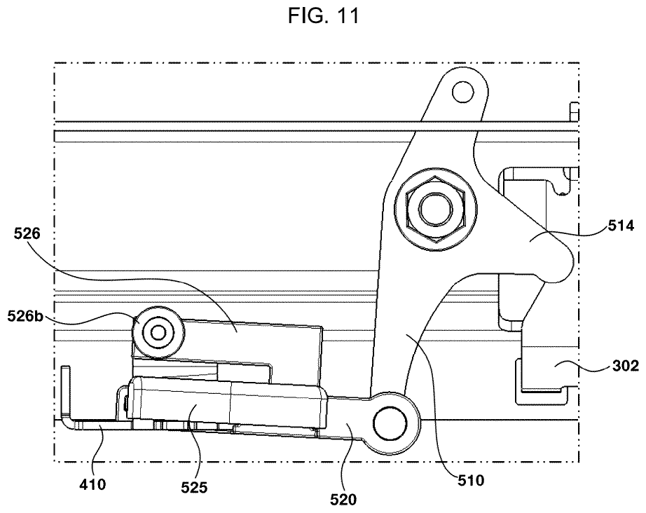

That is, the roller member 526b is connected to the outer surface of the connecting member 526a so as to be in contact with the upper surface of the lower rail 100. Further, as shown in FIG. 11, when the connecting member 526a is moved along the upper surface of the second support member 430 in the locking mode, a vertical clearance of the moving guide 500 with respect to the fixing guide 400 may be controlled together with the roller 202 (refer to FIG. 3), and thus a vertical clearance with respect to the upper rail 100 may be controlled.

As a result, in the present embodiment, a horizontal clearance and a vertical clearance of the guide bracket 520 with respect to the fixing guide 400 in the locking mode may be controlled through the rubber member 525 coupled to the first mounting portion 524 and the roller member 526b coupled to the connecting member 526a of the second mounting portion 526. In this manner, since vertical movement and horizontal movement of the upper rail 200 are prevented, vibration and shaking of the upper rail 200 may be prevented, and marketability of the seat may be improved.

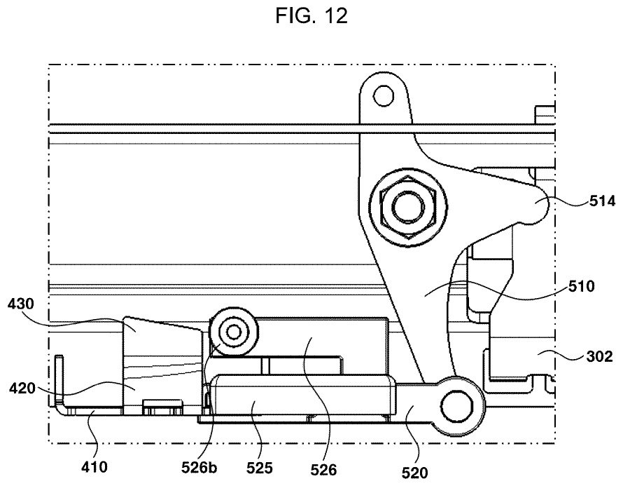

In addition, in the present embodiment, as shown in FIG. 12, when the locking module 300 is rotated according to switching from the locking mode to the moving mode, the guide bracket 520 is moved so as to be selectively disconnected from the fixing guide 400, and a space for the upper rail 200 to be moved along the lower rail 100 is secured. Accordingly, the upper rail 200 may be easily moved along the lower rail 100, and thus the occurrence of a difference in operating force due to movement of the upper rail 200 may be prevented.

According to the present disclosure, when a locking module is located to be caught by a lower rail, a rotation bracket is rotated by elastic force. Accordingly, a moving guide connected to the rotation bracket is slidably moved toward a fixing guide so as to be mounted on the fixing guide, and a vertical clearance and a horizontal clearance of the lower rail are controlled by the inclined shape of the fixing guide, thereby having an effect of preventing vertical movement and horizontal movement of a seat in a fixed state.

Therefore, the present disclosure has an effect of improving marketability of the seat by preventing the occurrence of vibration and shaking of the upper rail.

In addition, according to the present disclosure, when the locking module is unlocked from the lower rail, the rotation bracket is rotated by the locking module, and thus the moving guide is released from the fixing guide to enable sliding movement of the upper rail, thereby having an effect of preventing the occurrence of a difference in operating force due to sliding movement of the upper rail.

As is apparent from the above description, the present disclosure provides a long slide rail system for a vehicle seat, configured to prevent vertical movement and horizontal movement of the vehicle seat in a fixed state in such a manner that a rotation bracket is rotated by elastic force when a locking module is located to be caught by a lower rail, a moving guide connected to the rotation bracket is slidably moved toward a fixing guide so as to be mounted on the fixing guide, and a vertical clearance and a horizontal clearance of the lower rail are controlled by the inclined shape of the fixing guide.

Therefore, the present disclosure has an effect of improving marketability of the seat by preventing the occurrence of vibration and shaking of the upper rail.

In addition, according to the present disclosure, when the locking module is released from the lower rail, the rotation bracket is rotated by the locking module, and thus the moving guide is released from the fixing guide to enable sliding movement of the upper rail, thereby having an effect of preventing the occurrence of a difference in operating force due to sliding movement of the upper rail.

The present disclosure has been described in detail with reference to preferred embodiments shown in the drawings, but the embodiments are merely illustrative. It will be appreciated by those skilled in the art that various modifications may be made from the embodiments, and all or a part of the embodiments may be selectively combined with each other. Therefore, the true technical protection scope of the present disclosure should be defined by the technical spirit of the appended claims.

What is claimed is:

1. A long slide rail system for a vehicle seat, the long slide rail system comprising:
a lower rail configured to be fixedly installed on a vehicle so as to extend in lengthwise directions therealong;
an upper rail coupled to the lower rail, the upper rail being configured to enable a seat cushion to be slidably moved along the lower rail;
a locking module mounted on the upper rail, wherein the upper rail is configured to be slidably moved upon the locking module being unlocked from a locking hole formed in the lower rail;
a fixing guide coupled to the upper rail, the fixing guide being spaced apart from the locking module in forward-and-rearward directions; and
a moving guide configured to be selectively moved and connected to the fixing guide based on the locking module being locked in the locking hole, the moving guide configured to control, inside the lower rail, a horizontal clearance and a vertical clearance with respect to the upper rail.

2. The long slide rail system of claim 1, wherein the fixing guide comprises:
a main body fixedly coupled to the upper rail;
a pair of first support members positioned to face each other, the first support members formed to stand upright relative to the main body; and
a pair of second support members extending respectively from the first support members,
wherein a step is formed between each of the first support members and each of the second support members.

3. The long slide rail system of claim 2, wherein the first support members are disposed such that a gap formed between the first support members is gradually increased in a forward movement direction of the moving guide.

4. The long slide rail system of claim 2, wherein the second support members are formed to be integrated with the first support members, extend from the respective first support members in a state of being disposed parallel to each other, and include upper surfaces formed to be inclined upwards in a forward movement direction of the moving guide.

5. The long slide rail system of claim 2, wherein the moving guide comprises:
a pair of rotation brackets rotatably coupled to the locking module; and
guide brackets rotatably coupled to the respective rotation brackets, wherein the guide brackets are formed to be selectively moved in conjunction with rotation of the respective rotation brackets so as to be connected to the first support members and the second support members.

6. The long slide rail system of claim 5, wherein:
the rotation brackets are connected to each other by an elastic member, and
the rotation brackets are configured to, based on the locking module being rotated to be unlocked from the locking hole, rotate in conjunction with rotation of the locking module so as to temporarily and elastically move the respective guide brackets in a direction allowing the guide brackets to be disconnected from the first support members and the second support members.

7. The long slide rail system of claim 6, wherein each of the rotation brackets comprises a protruding member formed to protrude toward the locking module.

8. The long slide rail system of claim 5, wherein the guide bracket comprises:
a body portion connected to the main body of the fixing guide, the body portion configured to be movable in the forward-and-rearward directions;
first mounting portions formed to extend in leftward-and-rightward directions relative to the body portion, the first mounting portions configured to be selectively connected to the respective first support members; and
second mounting portions formed to extend upwards from the respective first mounting portions, the second mounting portions configured to be selectively connected to the respective second support members.

9. The long slide rail system of claim 8, wherein each of the first mounting portions comprises a rubber member coupled to an outer surface of each of the first mounting portions so as to contact a side surface of the lower rail.

10. The long slide rail system of claim 8, wherein each of the second mounting portions comprises:
a connecting member formed to have a C-shaped cross-section so as to accommodate a corresponding one of the second support members inside the connecting member; and
a roller member coupled to an outer surface of the connecting member so as to contact an upper surface of the lower rail.

11. The long slide rail system of claim 8, wherein the body portion comprises an elastic member connected to the main body of the fixing guide and disposed on a front side of the body portion, the elastic member being configured to selectively provide, to the body portion, an elastic restoring force in a compressed state when the body portion is moved toward the fixing guide.
